(19) United States
(12) Patent Application Publication
(10) Pub. No.: US 2012/0306773 A1
(43) Pub. Date: Dec. 6, 2012

(54) TOUCH CONTROL METHOD AND ELECTRONIC APPARATUS

(75) Inventor: Sip Kim Yeung, New Taipei City (TW)

(73) Assignee: ACER INCORPORATED, New Taipei City (TW)

(21) Appl. No.: 13/197,784

(22) Filed: Aug. 4, 2011

(30) Foreign Application Priority Data
May 31, 2011 (TW) 100119030

(51) Int. Cl. G06F 3/041

(52) U.S. Cl. 345/173

(57) ABSTRACT

A touch control method and an electronic apparatus are provided. The touch control method is adapted to the electronic apparatus which has a main screen and a touch screen. The touch screen is divided into a first portion and a second portion. In the touch control method, a touch operation performed by a user on the touch screen is detected, and whether the touch operation is performed within the first portion or the second portion of the touch screen is determined. If the touch operation is performed within the first portion of the touch screen, a frame displayed on the main screen is controlled according to the touch operation. If the touch operation is performed within the second portion of the touch screen, a frame displayed on the touch screen is controlled according to the touch operation.

### CROSS-REFERENCE TO RELATED APPLICATION

This application claims the priority benefit of Taiwan application serial no. 100119030, filed May 31, 2011. The entirety of the above-mentioned patent application is hereby incorporated by reference herein and made a part of this specification.

### BACKGROUND OF THE INVENTION

1. Field of the Invention

The invention generally relates to a touch control method and an electronic apparatus, and more particularly, to a touch control method operating two screens and an electronic apparatus.

2. Description of Related Art

Nowadays, media production relies mostly on notebooks or netbooks, while media consumption takes place mostly on tablet PCs and smart phones. Netbooks offer such advantages as low cost, high portability, and low productivity requirement therefore are the most potential electronic product for undertaking both media production and media consumption.

To be specific, media production demands high productivity but has low requirement to input device such as touch panel or touch screen. Apparatuses satisfying such criteria include desktop computers, all-in-one computers, and notebooks. Regarding media consumption, high portability and operability are demanded, and touch screen is usually adopted as the input and display device to reduce the volume and weight of the apparatus. Apparatuses satisfying such criteria include tablet PCs and smart phones. To achieve both high productivity and high operability, in some existing notebooks, the conventional keyboards and touch pads are replaced with touch screens as the input devices of these notebooks. Such notebooks may be dual-screen notebooks.

However, each of aforementioned apparatuses has its limitations. If high productivity is emphasized, the convenience of touch operation has to be sacrificed. If high portability and high operability are emphasized, no physical keyboard should be adopted. If both high productivity and high operability are to be achieved, the production cost will be greatly increased. Thereby, a resolution which offers both high productivity and convenient touch operation is to be provided.

### SUMMARY OF THE INVENTION

Accordingly, the invention is directed to a touch control method and an electronic apparatus in which both high productivity and operation convenience are achieved.

The invention provides a touch control method adapted to an electronic apparatus having a main screen and a touch screen. The touch screen is divided into a first portion and a second portion. In the touch control method, a touch operation performed by a user on the touch screen is detected, and whether the touch operation is performed within the first portion or the second portion of the touch screen is determined If the touch operation is performed within the first portion of the touch screen, a frame displayed on the main screen is controlled according to the touch operation. If the touch operation is performed within the second portion of the touch screen, a frame displayed on the touch screen is controlled according to the touch operation.

According to an embodiment of the invention, after the step of determining whether the touch operation is performed within the first portion or the second portion of the touch screen, the touch control method further includes following step. If the touch operation is performed in both the first portion and the second portion of the touch screen, the touch operation performed in the first portion and the second portion of the touch screen is switched to one of controlling only the frame displayed on the main screen, controlling only the frame displayed on the touch screen, and respectively controlling the frame displayed on the main screen and the frame displayed on the touch screen.

According to an embodiment of the invention, the step of controlling the frame displayed on the main screen according to the touch operation includes controlling the movement of a cursor in the frame displayed on the main screen according to a movement trajectory of the touch operation within the first portion of the touch screen.

According to an embodiment of the invention, the step of controlling the frame displayed on the main screen according to the touch operation includes determining a gesture produced by the movement of the touch operation within the first portion of the touch screen and controlling the frame displayed on the main screen to execute an operation corresponding to the gesture.

According to an embodiment of the invention, the step of controlling the frame displayed on the main screen according to the touch operation includes selecting an object displayed on the main screen according to the touch operation within the first portion of the touch screen and displaying or playing the object selected from the main screen on the touch screen according to another touch operation within the first portion of the touch screen.

According to an embodiment of the invention, the step of controlling the frame displayed on the main screen according to the touch operation includes selecting an object displayed on the main screen according to the touch operation within the first portion of the touch screen and dragging the object selected from the main screen to the touch screen when the touch operation moves from the first portion to the second portion.

According to an embodiment of the invention, after the step of dragging the object selected from the main screen to the touch screen, the touch control method further includes following steps. A control bar for operating the object is displayed in the second portion of the touch screen. The control bar includes a plurality of operation buttons. A touch operation performed by the user on one of the operation buttons is received, and an operation function corresponding to the operation button is executed on the object.

According to an embodiment of the invention, the step of controlling the frame displayed on the touch screen according to the touch operation includes determining a gesture produced by the movement of the touch operation on the touch screen and controlling the frame displayed on the touch screen to execute an operation corresponding to the gesture.

According to an embodiment of the invention, the main screen has a first size, the touch screen has a second size, the first portion of the touch screen has a third size, and the second portion of the touch screen has a fourth size, where a touch point of the touch operation in the first portion of the touch screen corresponds to a first control point on the main screen according to a first proportional relation between the first size and the third size, and a touch point of the touch operation in the second portion of the touch screen corresponds to a second control point on the touch screen according to a second proportional relation between the second size and the fourth size.

According to an embodiment of the invention, the first proportional relation is a first ratio obtained by scaling the third size to the first size and multiplying by a first weight, and the second proportional relation is a second ratio obtained by scaling the fourth size to the second size and multiplying by a second weight, where the first weight and the second weight are any numerical values greater than 1.

The invention provides an electronic apparatus including a main screen, a touch screen, and a processor. The touch screen is divided into a first portion and a second portion. The touch screen detects a touch operation performed by a user. The processor is coupled to the main screen and the touch screen. The processor receives the touch operation detected by the touch screen and determines whether the touch operation is performed within the first portion or the second portion of the touch screen. If the processor determines that the touch operation is performed within the first portion of the touch screen, the processor controls a frame displayed on the main screen according to the touch operation. Contrarily, if the processor determines that the touch operation is performed within the second portion of the touch screen, the processor controls the frame displayed on the touch screen according to the touch operation.

According to an embodiment of the invention, if the processor determines that the touch operation is performed in both the first portion and the second portion of the touch screen, the processor further switches the touch operation performed in the first portion and the second portion of the touch screen to one of controlling only the frame displayed on the main screen, controlling only the frame displayed on the touch screen, and respectively controlling the frame displayed on the main screen and the frame displayed on the touch screen.

According to an embodiment of the invention, the processor controls the movement of a cursor in the frame displayed on the main screen according to a movement trajectory of the touch operation within the first portion of the touch screen.

According to an embodiment of the invention, the processor determines a gesture produced by the movement of the touch operation within the first portion of the touch screen and controlling the frame displayed on the main screen to execute an operation corresponding to the gesture.

According to an embodiment of the invention, the processor selects an object displayed on the main screen according to the touch operation within the first portion of the touch screen and displaying or playing the object selected from the main screen on the touch screen according to another touch operation within the first portion of the touch screen.

According to an embodiment of the invention, the processor selects an object displayed on the main screen according to the touch operation within the first portion of the touch screen and drags the object selected from the main screen to the touch screen when the touch operation moves from the first portion to the second portion.

According to an embodiment of the invention, after the processor drags the object selected from the main screen to the touch screen, the processor further displays a control bar for operating the object in the second portion of the touch screen, where the control bar includes a plurality of operation buttons. After that, the processor receives a touch operation performed by the user on one of the operation buttons and executes an operation function corresponding to the operation button on the object.

According to an embodiment of the invention, the processor determines a gesture produced by the movement of the touch operation on the touch screen and controls the frame displayed on the touch screen to execute an operation corresponding to the gesture.

As described above, the invention provides a touch control method and an electronic apparatus, in which a touch screen of smaller size is disposed besides the main screen of the electronic apparatus, and the touch screen is divided into two portions to respectively operate the frames displayed on the main screen and the touch screen, so that both high productivity and operation convenience are achieved.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an electronic apparatus according to an embodiment of the invention.

FIG. 2 is a flowchart of a touch control method according to an embodiment of the invention.

FIG. 3 illustrates an example of a touch control method according to an embodiment of the invention.

FIG. 4 illustrates an example of a touch control method according to an embodiment of the invention.

FIG. 5 illustrates an example of a touch control method according to an embodiment of the invention.

FIG. 6 illustrates an example of a touch control method according to an embodiment of the invention.

FIG. 7 illustrates an example of a touch control method according to an embodiment of the invention.

FIG. 8 is a flowchart of a touch control method according to an embodiment of the invention.

FIG. 9 illustrates an example of corresponding positions of touch points according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the invention, no touch panel is disposed on the main screen of a notebook. Instead, a touch screen of smaller size (2″ to 3.5″) is used to replace a general touch pad as the input device of the notebook, and the touch screen is divided into two portions to respectively operate the frames displayed on the main screen and the touch screen. Through control over the touch screen and operations of the main screen and the touch screen, an electronic apparatus provided by the invention offers both high productivity and operation convenience.

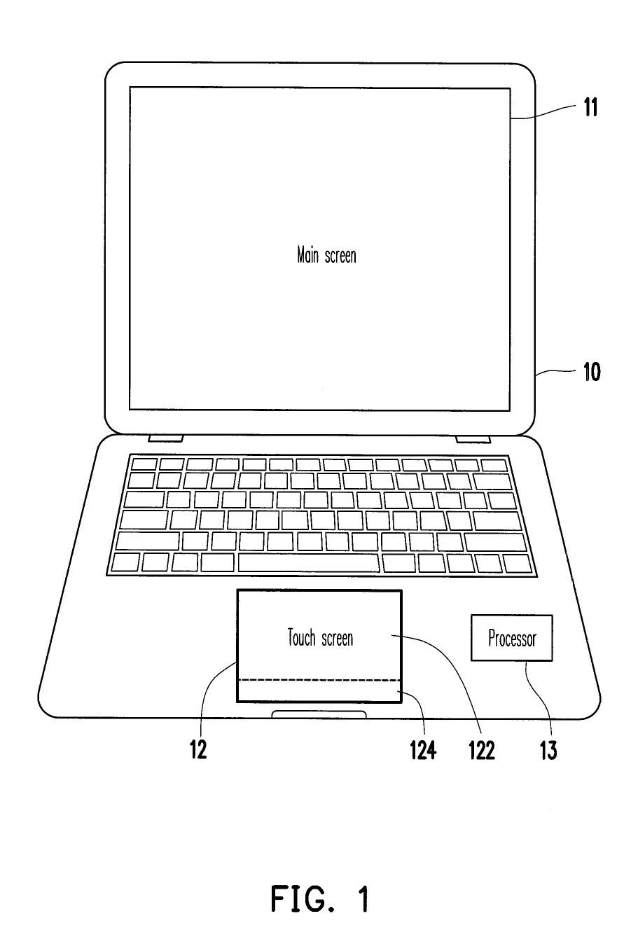

FIG. 1 is a diagram of an electronic apparatus according to an embodiment of the invention. Referring to FIG. 1, the electronic apparatus 10 in the present embodiment may be a notebook or a netbook including a main screen 11, a touch screen 12, and a processor 13. The functions of the main screen 11, the touch screen 12, and the processor 13 will be respectively explained below.

The main screen 11 may be a liquid crystal display (LCD), a light-emitting diode (LED) display, a field emission display (FED), or any other type of display.

The touch screen 12 may be a resistive, capacitive, or any other type of touch panel integrated with aforementioned display. The touch screen 12 provides both display and input functions. In the present embodiment, the touch screen 12 is divided into a first portion 122 and a second portion 124 for detecting touch operations performed by a user. The first portion 122 and the second portion 124 may be respectively the upper portion and the lower portion of the touch screen 12 separated by a dividing line. However, the invention is not limited herein, and the touch screen 12 may also be divided in other patterns.

The processor 13 may be a central processing unit (CPU) in the advanced RISC machine (ARM) structure, a general or special programmable microprocessor, a digital signal processor (DSP), a programmable controller, an application specific integrated circuit (ASIC), a programmable logic device (PLD), or any other similar device. The processor 13 executes all operations of the electronic apparatus 10 and controls frames displayed on the main screen 11 and the touch screen 12.

The operating system of a processor 13 in the ARM structure can support four displays and the display of two video streams at the same time. In the electronic apparatus 10 provided by the invention, the main screen 11 can be switched to an external device adopting a cathode ray tube (CRT) or a high-definition multimedia interface (HDMI), and meanwhile, the touch screen 12 is not affect and can provide touch control over the main screen 11 and the touch screen 12.

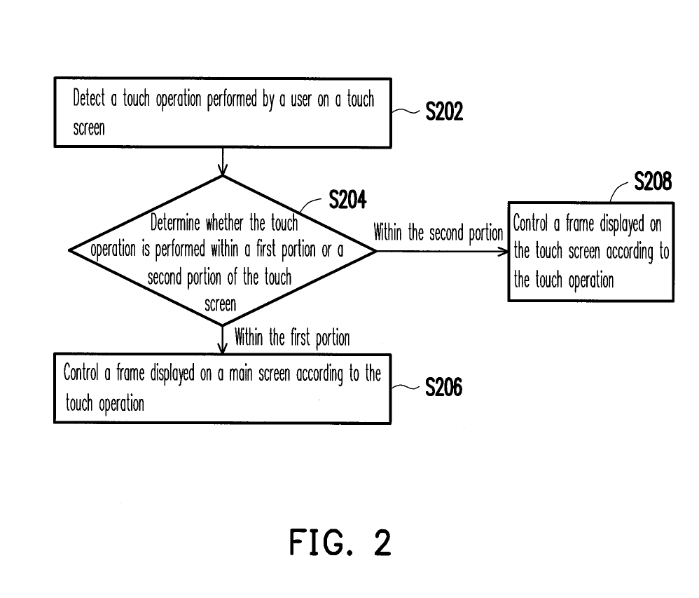

FIG. 2 is a flowchart of a touch control method according to an embodiment of the invention. Referring to FIG. 2, the touch control method in the present embodiment is adapted to the electronic apparatus 10 in FIG. 1. Below, the touch control method provided by the invention will be described in detail with reference to various components of the electronic apparatus 10.

First, the processor 13 detects a touch operation performed by a user on the touch screen 12 (step S202). Herein the touch screen 12 continuously detects the touch operation performed by the user by using a finger or any other object, generates a corresponding touch signal, and provides the touch signal to the processor 13 such that the processor 13 can detect or identify the user's touch operation.

Then, the processor 13 determines whether the touch operation is performed within the first portion 122 or the second portion 124 of the touch screen 12 (step S204). Herein the processor 13 obtains the division pattern of the first portion 122 and the second portion 124 on the touch screen 12 from the operating system or another application program and determines whether the touch operation is within the first portion 122 or the second portion 124 of the touch screen 12 according to the division pattern.

If the processor 13 determines that the touch operation is performed within the first portion 122 of the touch screen 12, the processor 13 controls the frame displayed on the main screen 11 according to the touch operation (step S206). To be specific, the touch operation detected by the processor 13 may be a tap, a double tap, a long tap, or a touch and drag operation, wherein the trajectory of the touch and drag operation can be further used for determining a cursor movement and a gesture.

The processor 13 controls the movement of a cursor in the frame displayed on the main screen 11 according to the movement trajectory of the touch operation within the first portion 122 of the touch screen 12. On the other hand, the processor 13 can further determine a gesture produced by the movement of the touch operation within the first portion 122 of the touch screen 12 and controls the frame displayed on the main screen 11 to execute an operation corresponding to the gesture accordingly.

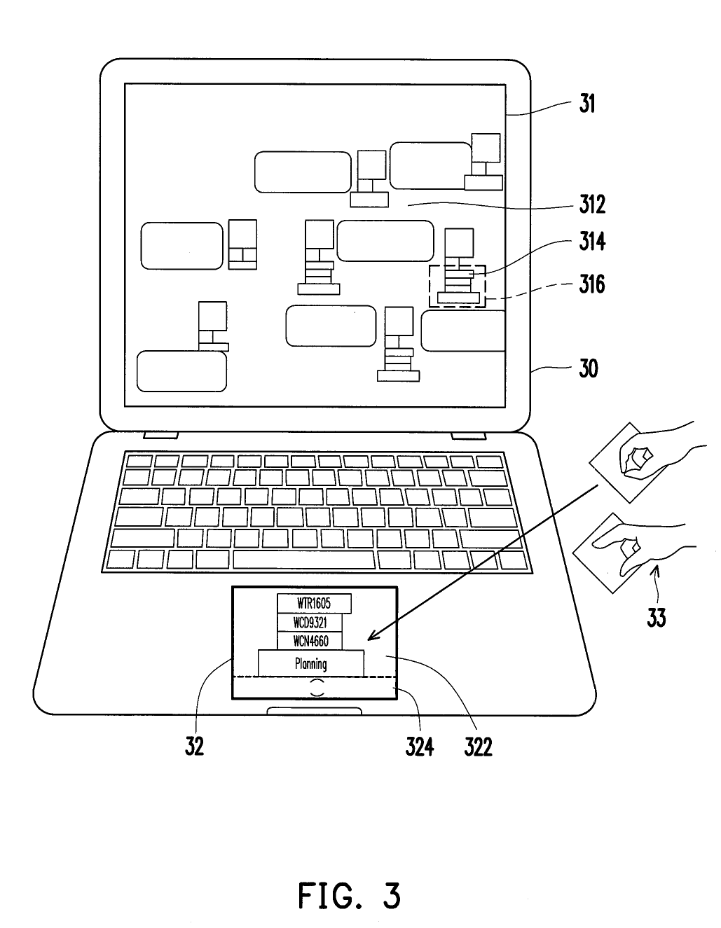

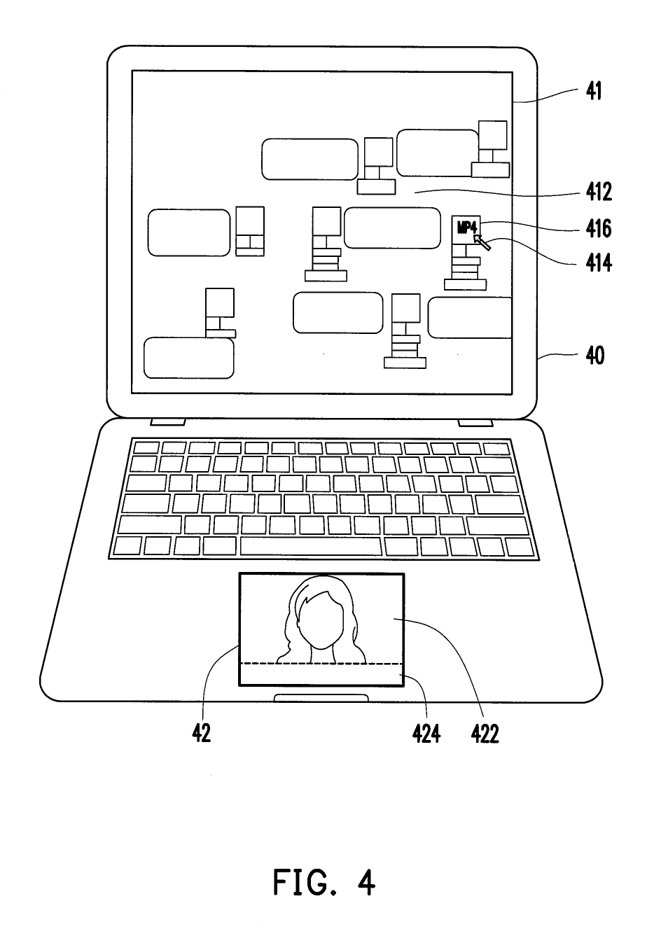

FIG. 3 and FIG. 4 illustrate examples of the touch control method according to an embodiment of the invention. Referring to FIG. 3 first, the electronic apparatus 30 displays a browsing frame of a file 312 on the main screen 31, and the touch screen 32 is divided into a first portion 322 and a second portion 324.

First, a user performs a touch and drag operation in the first portion 322 of the touch screen 32 to move a cursor (not shown) from the main screen 31 to the side of an object 314. Then, the user performs a pinch out touch operation 33 in the first portion 322 of the touch screen 32 to open a select box 316 around the object 314 and enlarge and display the image in the select box 316 on the touch screen 32. After that, the user further performs another touch and drag operation in the first portion 322 of the touch screen 32 to move the select box 316 displayed on the main screen 31 and correspondingly change the enlarged image displayed on the touch screen 32.

Thereafter, referring to FIG. 4, the electronic apparatus 40 displays a browsing frame of a file 412 on the main screen 41, and the touch screen 42 is divided into a first portion 422 and a second portion 424. First, a user performs a touch and drag operation in the first portion 422 of the touch screen 42 to move a cursor 414 displayed on the main screen 41 onto an object 416. Then, the user performs a touch operation (for example, a tap) in the first portion 422 of the touch screen 42 to select the object 416 displayed on the main screen 41. Finally, the user performs another touch operation (for example, a double tap) in the first portion 422 of the touch screen 42 to display or play the object 416 selected on the main screen 41 on the touch screen 42.

In step S204 illustrated in FIG. 2, if the processor 13 determines that the touch operation is performed within the second portion 124 of the touch screen 12, the processor 13 controls the frame displayed on the touch screen 12 according to the touch operation (step S208). Herein the processor 13 determines a gesture produced by the movement of the touch operation within the second portion 124 of the touch screen 12 and controls the frame displayed on the touch screen 12 to execute an operation corresponding to the gesture accordingly.

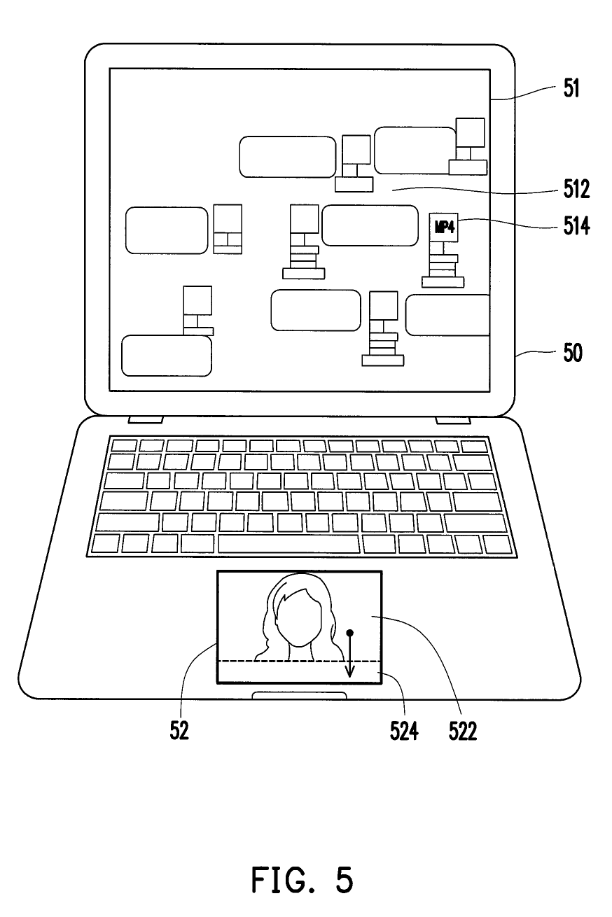

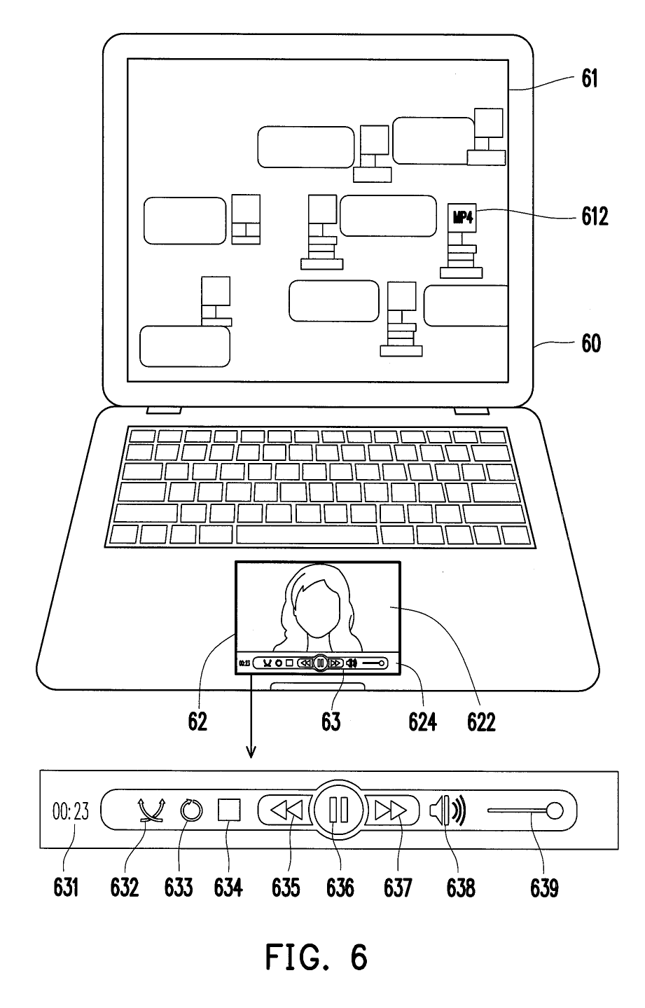

FIG. 5 and FIG. 6 illustrate examples of a touch control method according to an embodiment of the invention. Referring to FIG. 5 first, the electronic apparatus 50 displays a browsing frame of a file 512 on the main screen 51. A user performs a touch operation (for example, a touch and drag operation) in the first portion 522 of the touch screen 52 to select an object 514 displayed on the main screen 51. When the touch and drag touch operation moves from the first portion 522 to the second portion 524 (i.e., crosses over the dividing line between the two portions) of the touch screen 52, the electronic apparatus 50 drags the object 514 selected on the main screen 51 to the touch screen 52 to display or play.

Next, referring to FIG. 6, similar to the example illustrated in FIG. 5, the electronic apparatus 60 in the present embodiment further displays a control bar 63 for operating the object 612 in the second portion 624 of the touch screen 62 when the object 612 is dragged to the touch screen 62 to be displayed or played. Besides a play time 631, the control bar 63 also displays a plurality of operation buttons (including a random play button 632, a recurrent play button 633, a stop button 634, a rewind button 635, a play/pause button 636, a forward button 637, a mute button 638, and a volume adjustment bar 639). The electronic apparatus 60 receives a touch operation performed by a user on any one of the operation buttons and executes an operation function corresponding to the operation button on the object 612.

It should be noted that displaying a control bar in the second portion of the touch screen is only an embodiment of the invention. However, the invention is not limited thereto, and in another embodiment, the second portion of the touch screen can also be configured to detect and determine a gesture corresponding to a touch operation performed by a user, so as to execute an operation corresponding to the gesture on a frame or object displayed on the touch screen.

Aforementioned gesture may be a tap, a double tap, a long tap, a flick, a panning, a pinch, a two-finger long tap, or a three-finger or four-finger click, drag, or long press, etc. Besides, aforementioned gesture may also be corresponding to a pattern formed by a touch and drag operation performed by the user on the touch screen by using a single finger (for example, dragging a rectangular or circular trajectory). However, aforementioned gestures are only examples, and the scope thereof is not limited herein. Those skilled in the art can associate different gestures to different operation functions according to the actual requirement.

The invention further provides an instant switching mechanism regarding the method described above of controlling the main screen and the touch screen by using different portions of the touch screen, in which a user is allowed to control the main screen and the touch screen by using the entire touch screen or different portions of the touch screen in any situation. This will be explained below with reference to an embodiment.

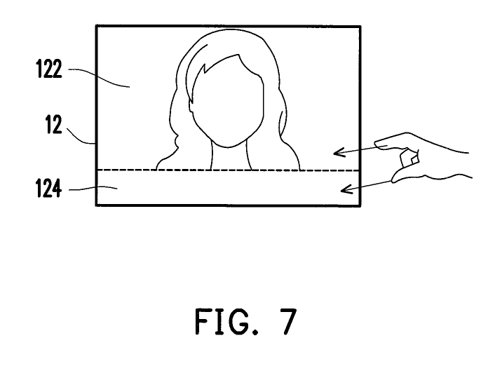

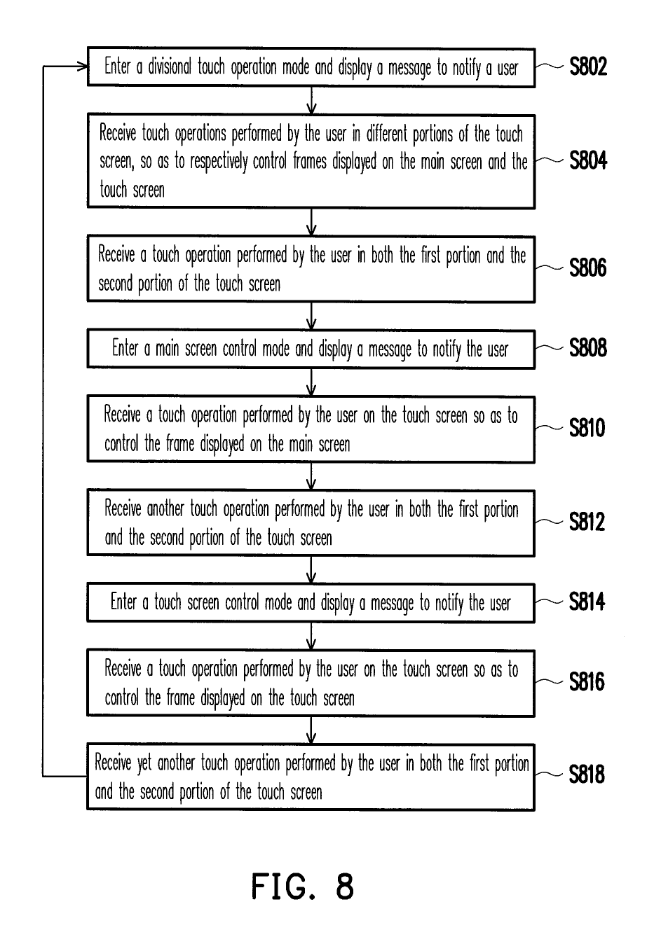

FIG. 7 illustrates an example of a touch control method according to an embodiment of the invention. FIG. 8 is a flowchart of a touch control method according to an embodiment of the invention. Referring to FIG. 7, in the present embodiment, a user uses two fingers to touch the first portion 122 and the second portion 124 of the touch screen 12 at the same time, so as to switch between different touch operation modes.

Next, referring to FIG. 8, when the processor 13 executes an application program supporting divisional touch operations or receives a divisional touch operation instruction issued by a user, the processor 13 enters a divisional (i.e., dividing the touch screen into a first portion and a second portion) touch operation mode and displays a message on the main screen 11 to notify the user (step S802). In this mode, the processor 13 can receive touch operations performed by the user in different portions of the touch screen 12 to respectively control the frames displayed on the main screen 11 and the touch screen 12 (step S804).

While displaying a frame, the processor 13 continuously detects any touch operation performed by the user on the touch screen 12. When the processor 13 receives a touch operation performed by the user in both the first portion and the second portion (step S806), the processor 13 enters a main screen control mode and displays a message on the main screen 11 or the touch screen 12 to notify the user (step S808). In this mode, the processor 13 can receive a touch operation performed by the user on the touch screen 12 and control the frame displayed on the main screen 11 according to the touch operation regardless of whether the touch operation is performed in the first portion or the second portion (step S810).

When the processor 13 receives another touch operation performed by the user in both the first portion and the second portion (step S812), the processor 13 enters a touch screen control mode and displays a message on the main screen 11 or the touch screen 12 to notify the user (step S814). In this mode, the processor 13 can receive a touch operation performed by the user on the touch screen 12 and control the frame displayed on the touch screen 12 according to the touch operation regardless of whether the touch operation is performed in the first portion or the second portion (step S816). Finally, when the processor 13 receives yet another touch operation performed by the user in both the first portion and the second portion (step S818), step S802 is executed again to enter the divisional touch operation mode and display a message on the main screen 11 to notify the user.

Additionally, in the invention, when the first portion and the second portion of the touch screen detect touch operations performed by a user, a detected touch point may respectively correspond to a control point on the main screen and the touch screen according to the proportional relation between the first portion and the main screen and the proportional relation between the second portion and the touch screen and can be used for controlling an object corresponding to the control point on the main screen or the touch screen.

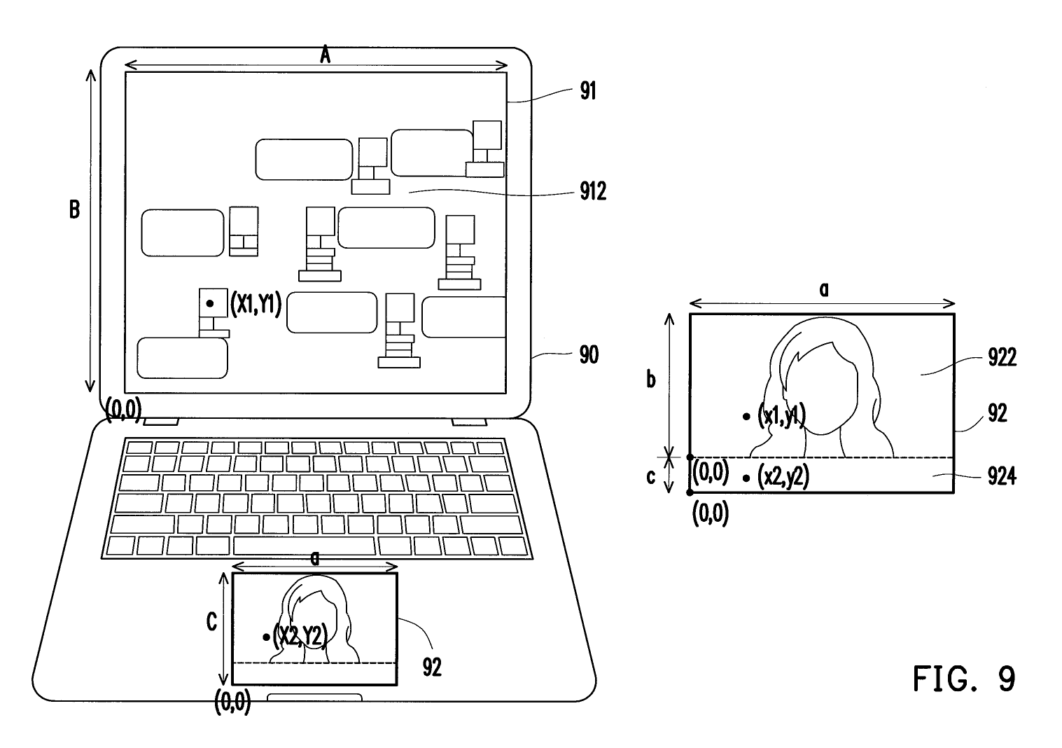

FIG. 9 illustrates an example of corresponding positions of touch points according to an embodiment of the invention. Referring to FIG. 9, in the electronic apparatus 90 of the present embodiment, the size of the main screen 91 is A×B, and the size of the touch screen 92 is a×C, wherein the size of the first portion is a×b, and the size of the second portion is a×c.

In the present embodiment, the touch point of a touch operation in the first portion of the touch screen 92 corresponds to a control point on the main screen according to the proportional relation between the size A×B and the size a×b, and the touch point of the touch operation in the second portion of the touch screen corresponds to a control point on the touch screen according to the proportional relation between the size a×C and the size a×c.

When the user touches the touch point (x1,y1) in the first portion of the touch screen, the coordinates of the corresponding control point on the main screen are (X1, Y1), and the proportional relation is:

X1=(A/a)×x1

Y1=(B/b)×y1

On the other hand, when the user touches the touch point (x2,y2) in the second portion of the touch screen, the coordinates of the corresponding control point on the touch screen are (X2, Y2), and the proportional relation is:

X2=x2

Y2=(C/c)×y2

Aforementioned proportional relation is directly corresponding to the sizes of the touch screen and the main screen. However, the scope of the proportional relation is not limited herein, and in another embodiment, the proportional relation may be multiplied by a weight according to the user's requirement. To be specific, the proportional relation between the first portion of the touch screen and the main screen is a ratio obtained by scaling the size a×b to the size A×B and multiplying by a weight w1, and the proportional relation between the second portion of the touch screen and the touch screen itself is a ratio obtained by scaling the size a×c to the size a×C and multiplying by a weight w2, wherein the weights w1 and w2 are any numerical values greater than 1.

In summary, the invention provides a touch control method and an electronic apparatus, in which the control mode of the touch screen is instantly switched through control over the touch screen and operations of the main screen and the touch screen according to the user requirement, so that the electronic apparatus in the invention achieves both high productivity and operation convenience.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch control method, adapted to an electronic apparatus having a main screen and a touch screen, wherein the touch screen is divided into a first portion and a second portion, the touch control method comprising:
detecting a touch operation performed by a user on the touch screen;
determining whether the touch operation is performed within the first portion or the second portion of the touch screen;
controlling a frame displayed on the main screen according to the touch operation when the touch operation is performed within the first portion of the touch screen; and
controlling a frame displayed on the touch screen according to the touch operation when the touch operation is performed within the second portion of the touch screen.

2. The touch control method according to claim 1, wherein after the step of determining whether the touch operation is performed within the first portion or the second portion of the touch screen, the touch control method further comprises:
switching the touch operation performed in the first portion and the second portion of the touch screen to one of controlling only the frame displayed on the main screen, controlling only the frame displayed on the touch screen, and respectively controlling the frame displayed on the main screen and the frame displayed on the touch screen when the touch operation is performed in both the first portion and the second portion of the touch screen.

3. The touch control method according to claim 1, wherein the step of controlling the frame displayed on the main screen according to the touch operation comprises:
controlling movement of a cursor in the frame displayed on the main screen according to a movement trajectory of the touch operation within the first portion of the touch screen.

4. The touch control method according to claim 1, wherein the step of controlling the frame displayed on the main screen according to the touch operation comprises:
determining a gesture produced by movement of the touch operation within the first portion of the touch screen; and
controlling the frame displayed on the main screen to execute an operation corresponding to the gesture.

5. The touch control method according to claim 1, wherein the step of controlling the frame displayed on the main screen according to the touch operation comprises:
selecting an object displayed on the main screen according to the touch operation within the first portion of the touch screen; and
displaying or playing the object selected from the main screen on the touch screen according to another touch operation within the first portion of the touch screen.

6. The touch control method according to claim 1, wherein the step of controlling the frame displayed on the main screen according to the touch operation comprises:
selecting an object displayed on the main screen according to the touch operation within the first portion of the touch screen; and
dragging the object selected from the main screen to the touch screen when the touch operation moves from the first portion to the second portion.

7. The touch control method according to claim 6, wherein after the step of dragging the object selected from the main screen to the touch screen, the touch control method further comprises:
displaying a control bar for operating the object in the second portion of the touch screen, wherein the control bar comprises a plurality of operation buttons; and
receiving a touch operation performed by the user on one of the operation buttons, and executing an operation function corresponding to the operation button on the object.

8. The touch control method according to claim 1, wherein the step of controlling the frame displayed on the touch screen according to the touch operation comprises:
determining a gesture produced by movement of the touch operation on the touch screen; and
controlling the frame displayed on the touch screen to execute an operation corresponding to the gesture.

9. The touch control method according to claim 1, wherein the main screen has a first size, the touch screen has a second size, the first portion of the touch screen has a third size, and the second portion of the touch screen has a fourth size, wherein a touch point of the touch operation in the first portion of the touch screen corresponds to a first control point on the main screen according to a first proportional relation between the first size and the third size, and a touch point of the touch operation in the second portion of the touch screen corresponds to a second control point on the touch screen according to a second proportional relation between the second size and the fourth size.

10. The touch control method according to claim 9, wherein the first proportional relation is a first ratio obtained by scaling the third size to the first size and multiplying by a first weight, and the second proportional relation is a second ratio obtained by scaling the fourth size to the second size and multiplying by a second weight, wherein the first weight and the second weight are any numerical values greater than 1.

11. An electronic apparatus, comprising:
a main screen;
a touch screen, divided into a first portion and a second portion, detecting a touch operation performed by a user; and
a processor, coupled to the main screen and the touch screen, receiving the touch operation detected by the touch screen and determining whether the touch operation is performed within the first portion or the second portion of the touch screen, wherein
when the touch operation is performed within the first portion of the touch screen, the processor controls a frame displayed on the main screen according to the touch operation; and
when the touch operation is performed within the second portion of the touch screen, the processor controls a frame displayed on the touch screen of the touch operation.

12. The electronic apparatus according to claim 11, wherein the processor further switches the touch operation performed in the first portion and the second portion of the touch screen to one of controlling only the frame displayed on the main screen, controlling only the frame displayed on the touch screen, and respectively controlling the frame displayed on the main screen and the frame displayed on the touch screen when the processor determines that the touch operation is performed in both the first portion and the second portion of the touch screen.

13. The electronic apparatus according to claim 11, wherein the processor controls movement of a cursor in the frame displayed on the main screen according to a movement trajectory of the touch operation within the first portion of the touch screen.

14. The electronic apparatus according to claim 11, wherein the processor determines a gesture produced by movement of the touch operation within the first portion of the touch screen and controls the frame displayed on the main screen to execute an operation corresponding to the gesture.

15. The electronic apparatus according to claim 11, wherein the processor selects an object displayed on the main screen according to the touch operation within the first portion of the touch screen and displays or plays the object selected from the main screen on the touch screen according to another touch operation within the first portion of the touch screen.

16. The electronic apparatus according to claim 11, wherein the processor selects an object displayed on the main screen according to the touch operation within the first portion of the touch screen and drags the object selected from the main screen to the touch screen when the touch operation moves from the first portion to the second portion.

17. The electronic apparatus according to claim 16, wherein after the processor drags the object selected from the main screen to the touch screen, the processor further displays a control bar for operating the object in the second portion of the touch screen, wherein the control bar comprises a plurality of operation buttons, and the processor receives a touch operation performed by the user on one of the operation buttons and executes an operation function corresponding to the operation button on the object.

18. The electronic apparatus according to claim 11, wherein the processor determines a gesture produced by movement of the touch operation on the touch screen and controls the frame displayed on the touch screen to execute an operation corresponding to the gesture.

19. The electronic apparatus according to claim 11, wherein the main screen has a first size, the touch screen has a second size, the first portion of the touch screen has a third size, and the second portion of the touch screen has a fourth size, wherein a touch point of the touch operation in the first portion of the touch screen corresponds to a first control point on the main screen according to a first proportional relation between the first size and the third size, and a touch point of the touch operation in the second portion of the touch screen corresponds to a second control point on the touch screen according to a second proportional relation between the second size and the fourth size.

20. The electronic apparatus according to claim 19, wherein the first proportional relation is a first ratio obtained by scaling the third size to the first size and multiplying by a first weight, and the second proportional relation is a second ratio obtained by scaling the fourth size to the second size and multiplying by a second weight, wherein the first weight and the second weight are any numerical values greater than 1.
